(19) United States
(12) Patent Application Publication
(10) Pub. No.: US 2017/0025089 A1
(43) Pub. Date: Jan. 26, 2017

(54) DEVICES AND METHODS FOR FACILITATING TRANSMISSION OF VIDEO STREAMS IN REMOTE DISPLAY APPLICATIONS

(71) Applicant: QUALCOMM Incorporated, San Diego, CA (US)

(72) Inventors: Lochan Verma, San Diego, CA (US); Vijayalakshmi Rajasundaram Raveendran, San Diego, CA (US); Amir Naveed, San Diego, CA (US)

(21) Appl. No.: 15/204,336

(22) Filed: Jul. 7, 2016

Related U.S. Application Data
(60) Provisional application No. 62/195,691, filed on Jul. 22, 2015.

(51) Int. Cl. G09G 5/00; G06F 13/42; G06F 3/14

(52) U.S. Cl. CPC G09G 5/006; G06F 3/1454; G06F 13/4282

(57) ABSTRACT

Source and sink devices are adapted to facilitate streaming of screen content data over a USB communication channel. According to one example, a source device can capture GPU-executable video data at an input of a GPU, and transmit a graphics domain data frame including the captured video data on a data plane of a USB communication channel. Further, a command message may be transmitted on a management plane of the USB communication channel. The sink device may receive the graphics domain data frame with the captured video data on the data plane, and may receive the command message on the management plane. The sink device may render and display the video data. Other aspects, embodiments, and features are also included.

### PRIORITY CLAIM

The present application for Patent claims priority to Provisional Application No. 62/195,691 entitled “Media Agnostic Graphics Offload” filed Jul. 22, 2015, and assigned to the assignee hereof and hereby expressly incorporated by reference herein.

### TECHNICAL FIELD

The technology discussed below relates in some aspects to techniques for streaming screen content from a source device to a sink device.

### BACKGROUND

With modern electronic devices, it sometimes occurs that a user desires to display content, such as video, audio, and/or graphics content, from one electronic device on another electronic device. In many instances the ability to convey the content wirelessly is also desired. Generally speaking, in such a wireless display system, a first wireless device “source device” may provide content via a wireless link to a second wireless device “sink device” where the content can be played back or displayed. The content may be played back at both a local display of the source device and at a display of the sink device.

By utilizing wireless capabilities to form a wireless connection between the two devices, a source device can take advantage of better display and/or audio capabilities of a sink device (e.g., a digital television, projector, audio/video receiver, high-resolution display, etc.) to display content that is initially stored in, or streamed to, the source device. As the demand for such technologies continues to increase, research and development continue to advance and enhance the user experience.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Various examples and implementations of the present disclosure facilitate transmission of graphics data from a source device to a sink device over a universal serial bus (USB) communication channel. According to at least one aspect of this disclosure, source devices may include a universal serial bus (USB) communications interface, a graphics processing unit (GPU), and a processing circuit coupled to the USB communications interface and the GPU. The processing circuit may include logic to capture GPU-executable video data at an input of the GPU, where the GPU-executable video data includes a set of graphics commands. The processing circuit may further include logic to transmit a graphics domain data frame on a data plane via the USB communications interface, where the graphics domain data frame includes the GPU-executable video data. The processing circuit may also include logic to transmit at least one command message on a management plane via the USB communications interface.

Further aspects provide methods operational on source devices and/or source devices including means to perform such methods. One or more examples of such methods may include capturing video data at an input of a graphics processing unit (GPU), where the video data includes a set of graphics commands executable by a GPU. A graphics domain data frame may be transmitted on a data plane via a universal serial bus (USB) communications channel, where the graphics domain data frame includes the captured video data. At least one command message may also be transmitted on a management plane via the USB communications channel.

Additional aspects provide sink devices including a universal serial bus (USB) communications interface, data streaming logic, a graphics processing unit (GPU) and a display device. The data streaming logic may be configured to receive a graphics domain data frame on a data plane via the USB communications interface, where the graphics domain data frame includes video data including a set of graphics commands executable by a graphics processing unit. The data streaming logic may be further configured to receive at least one command message on a management plane via the USB communications interface. The GPU may be configured to render the video data included in the received graphics domain data frame, and the display device may be configured to render the video data.

Still further aspects provide methods operational on sink devices and/or sink devices including means to perform such methods. One or more examples of such methods may include receiving a graphics domain data frame on a data plane via a universal serial bus (USB) communications channel, where the graphics domain data frame includes video data with a set of graphics commands executable by a graphics processing unit. At least one command message may be received on a management plane via the USB communications channel. The video data included in the received graphics domain data frame may be rendered, and the rendered video data may be displayed.

Other aspects, features, and embodiments associated with the present disclosure will become apparent to those of ordinary skill in the art upon reviewing the following description in conjunction with the accompanying figures.

### DRAWINGS

FIG. 1 is a conceptual block diagram of an example remote display system in which a source device is configured to transmit screen content to a sink device over a communication channel, in accordance with one or more aspects of this disclosure.

FIG. 2 is a block diagram illustrating select components of a source device according to at least one example of the present disclosure.

FIG. 3 is a block diagram is shown illustrating select components of a sink device according to at least one example.

FIG. 4 is a conceptual block diagram illustrating an example of a graphics domain transmission from a source device to a sink device according to at least one implementation of the present disclosure.

FIG. 5 is a conceptual block diagram of a source device and a sink device communicating over a management plane and a data plane according to as least one example of the disclosure.

FIG. 6 is a flow diagram illustrating an example of message flow in the management plane according to at least one implementation.

FIG. 7 is a block diagram illustrating one example of a header section for a command message according to the present disclosure.

FIG. 8 is a block diagram illustrating at least one example of a header section of a graphics domain data frame for transmitting video data in the graphics domain.

FIG. 9 is a block diagram illustrating at least one example of a payload section of a graphics domain data frame for transmitting video data in the graphics domain.

FIG. 10 is a flow diagram illustrating a method operational on a source device according to at least one example.

FIG. 11 is a flow diagram illustrating a method operational on a sink device according to at least one example.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

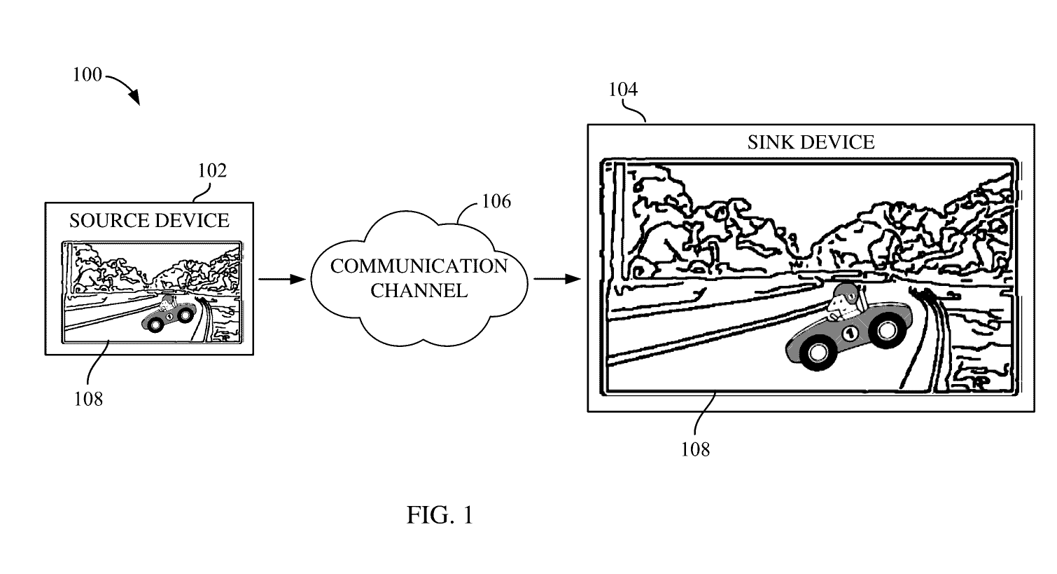

The various concepts presented throughout this disclosure may be implemented across a broad variety of wireless communication systems, network architectures, and communication standards. Referring now to FIG. 1, a conceptual diagram of an example remote display system in accordance with one or more aspects of the disclosure is illustrated. The remote display system 100 facilitates transmission of graphics commands from a source device 102 to a sink device 104 over a communication channel 106.

The source device 102 may be an electronic device adapted to transmit screen content data 108 to a sink device 104 over a communication channel 106. Examples of a source device 102 include, but are not limited to devices such as smartphones or other mobile handsets, tablet computers, laptop computers, e-readers, digital video recorders (DVRs), desktop computers, wearable computing devices (e.g., smart watches, smart glasses, and the like), and/or other communication/computing device that communicates, at least partially, through wireless and/or non-wireless communications.

The sink device 104 may be an electronic device adapted to receive the screen content data 108 conveyed over the communication channel 106 from the source device 102. Examples of a sink device 104 may include, but are not limited to devices such as smartphones or other mobile handsets, tablet computers, laptop computers, e-readers, digital video recorders (DVRs), desktop computers, wearable computing devices (e.g., smart watches, smart glasses, and the like), televisions, monitors, and/or other communication/computing device with a visual display and with wireless and/or non-wireless communication capabilities.

The communication channel 106 is a channel capable of propagating communicative signals between the source device 102 and the sink device 104. In some examples, the communication channel 106 may be a Universal Serial Bus (USB) communication channel. For instance, the USB-compliant communication channel 106 may be a wired communication channel 106 implementing wired USB (e.g., USB 2.0, USB 3.0, etc.). In other instance, the USB-compliant communication channel 106 may be a wireless communication channel 106 implementing wireless USB (WUSB) (as promoted by the Wireless USB Promoter Group). The USB-compliant communication channel 106 may be a media agnostic USB (MAUSB) implementation in at least some examples. As used herein, the term USB or USB interface may accordingly include wired USB, wireless USB, and media agnostic USB.

As depicted by FIG. 1, the source device 102 may have video data 108 to be conveyed. The source device 102 can convey the video data 108 via the communication channel 106 to the sink device 104. In some examples, a “graphics domain” transmission method may be used by the source device 102 to stream deconstructed video frames to the sink device 104. Graphics domain transmissions may be accomplished by capturing the video data 108 at the source device (e.g., at an input of a GPU of the source device 102) in the form of graphics commands (e.g., OpenGL/ES commands, vendor-specific commands) and texture elements, and conveying the graphics commands and texture elements to the sink device 104. The sink device 104 (e.g., a GPU at the sink device 104) may render the graphics commands and texture elements into displayable frames, and output the rendered frames at a display of the sink device 104.

Graphics domain transmission methods can be beneficial in several aspects. For example, if the sink device 104 employs a display with a greater resolution than the source device 102, the sink device 104 can employ the graphics commands (e.g., OpenGL/ES commands or vendor-specific commands) and texture elements to render the frame at a higher resolution with similar quality. Another example includes the ability to send a texture element that may be used in many frames, enabling the source device 102 to send the texture element a single time to be employed by the sink device 104 to render several different frames.

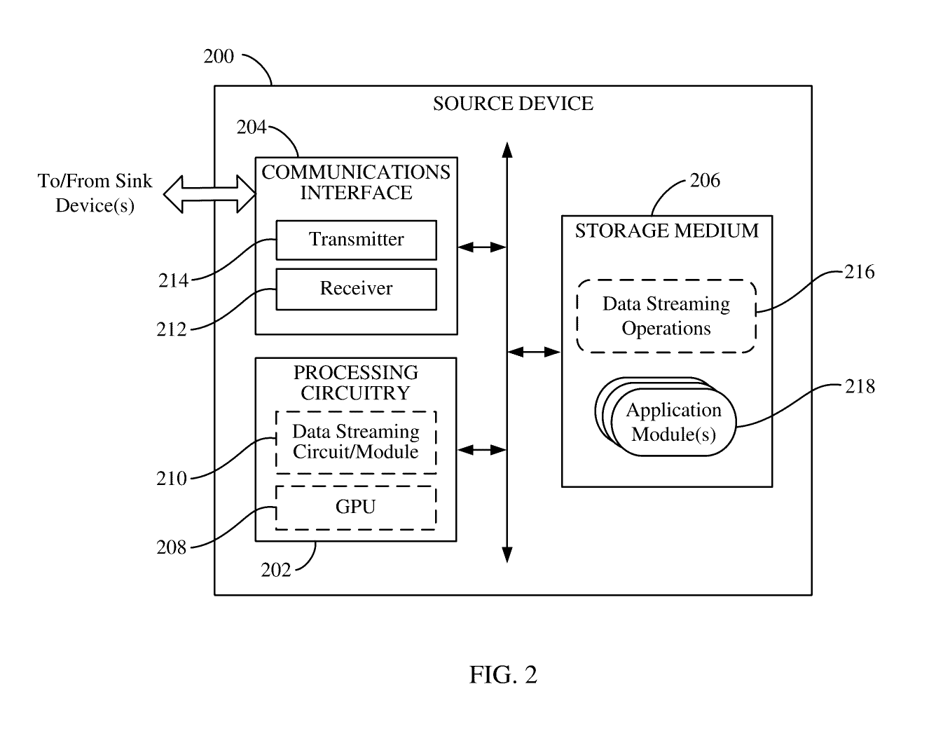

FIG. 2 shows a block diagram illustrating select components of a source device 200 according to at least one example of the present disclosure. The source device 200 includes processing circuit or circuitry 202 coupled to or placed in electrical communication with a communications interface 204 and a storage medium 206.

The processing circuitry 202 includes circuitry arranged to obtain, process and/or send data, control data access and storage, issue commands, and control other desired operations. The processing circuitry 202 may include circuitry adapted to implement desired programming provided by appropriate media, and/or circuitry adapted to perform one or more functions described in this disclosure. For example, the processing circuitry 202 may be implemented as one or more processors, one or more controllers, and/or other structure configured to execute executable programming and/or execute specific functions. Examples of the processing circuitry 202 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuitry 202 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuitry 202 are for illustration and other suitable configurations within the scope of the present disclosure are also contemplated.

The processing circuitry 202 can include circuitry adapted for processing data, including the execution of programming, which may be stored on the storage medium 206. As used herein, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuitry 202 may include a graphics processing unit (GPU) 208 and/or a data streaming circuit or module 210. The GPU 208 generally includes circuitry and/or programming (e.g., programming stored on the storage medium 206) adapted for processing video data and rendering frames of video data based on one or more graphics commands (e.g., OpenGL/ES commands, vendor-specific commands) and texture elements for display by a user interface.

The data streaming circuit/module 210 may include circuitry and/or programming (e.g., programming stored on the storage medium 206) adapted to stream video data in the form of graphics commands (e.g., OpenGL/ES commands, vendor-specific commands) and texture elements to a sink device over a USB communications interface. In some examples, the data streaming circuit/module 210 may send command messages in a management plane and data messages in a data plane, as described in more detail below. In some examples, the data streaming circuit/module 210 may capture the video data (e.g., graphics commands and/or texture elements) to be sent as data message at an input of a GPU, such as the GPU 208.

As used herein, reference to circuitry and/or programming associated with the source device 200 may be generally referred to as logic (e.g., logic gates and/or data structure logic).

The communications interface 204 is configured to facilitate wireless and/or wired communications of the source device 200. For example, the communications interface 204 may include circuitry and/or programming adapted to facilitate the communication of information bi-directionally with respect to one or more sink devices. In at least one example, the communications interface 204 may be coupled to one or more antennas (not shown), and may include wireless transceiver circuitry, including at least one receiver 212 (e.g., one or more receiver chains) and/or at least one transmitter 214 (e.g., one or more transmitter chains). The communications interface 204 may be configured as a USB interface according to at least one example. Such a USB interface is capable of facilitating USB-compliant communication of information bi-directionally with respect to one or more sink devices.

The storage medium 206 may represent one or more processor-readable devices for storing programming, such as processor executable code or instructions (e.g., software, firmware), electronic data, databases, or other digital information. The storage medium 206 may also be used for storing data that is manipulated by the processing circuitry 202 when executing programming. The storage medium 206 may be any available media that can be accessed by a general purpose or special purpose processor, including portable or fixed storage devices, optical storage devices, and various other mediums capable of storing, containing and/or carrying programming. By way of example and not limitation, the storage medium 206 may include a processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 206 may be coupled to the processing circuitry 202 such that at least some of the processing circuitry 202 can read information from, and write information to, the storage medium 206. That is, the storage medium 206 can be coupled to the processing circuitry 202 so that the storage medium 206 is at least accessible by the processing circuitry 202, including examples where the storage medium 206 is integral to the processing circuitry 202 and/or examples where the storage medium 206 is separate from the processing circuitry 202 (e.g., resident in the source device 200, external to the source device 200, distributed across multiple entities).

The storage medium 206 may include programming stored thereon. Such programming, when executed by the processing circuitry 202, can cause the processing circuitry 202 to perform one or more of the various functions and/or process steps described herein. In at least some examples, the storage medium 206 may include data streaming operations 216. The data streaming operations 216 are adapted to cause the processing circuitry 202 to stream video data in the form of graphics commands (e.g., OpenGL/ES commands, vendor-specific commands) and texture elements to a sink device. In some examples, the data streaming operations 216 may include management plane operations and/or data plane operations.

The storage medium 206 may also include application modules 218 which may each represent an application provided by an entity that manufactures the source device 200, programming operating on the source device 200, and/or an application developed by a third-party for use with the source device 200. Examples of application modules 218 may include applications for gaming, shopping, travel routing, maps, audio and/or video presentation, word processing, spreadsheets, voice and/or calls, weather, etc. One or more application modules 218 may include texture elements associated therewith. For example, where a gaming application of the application modules 218 entails the slicing of falling fruit (e.g., watermelons, avocados, pineapples, etc.), there may be texture elements associated with the gaming application that may include a graphical representation of each of the types of fruit, as well as backgrounds. Such texture elements may be stored in a plurality of formats, such as RGBα 8888, RGBα 4444, RGBα 5551, RGB 565, Yα 88, and α8.

According to one or more aspects of the present disclosure, the processing circuitry 202 is adapted to perform (independently or in conjunction with the storage medium 206) any or all of the processes, functions, steps and/or routines for any or all of the source devices described herein (e.g., source device 102, source device 200). As used herein, the term “adapted” in relation to the processing circuitry 202 may refer to the processing circuitry 202 being one or more of configured, employed, implemented, and/or programmed (in conjunction with the storage medium 206) to perform a particular process, function, step and/or routine according to various features described herein.

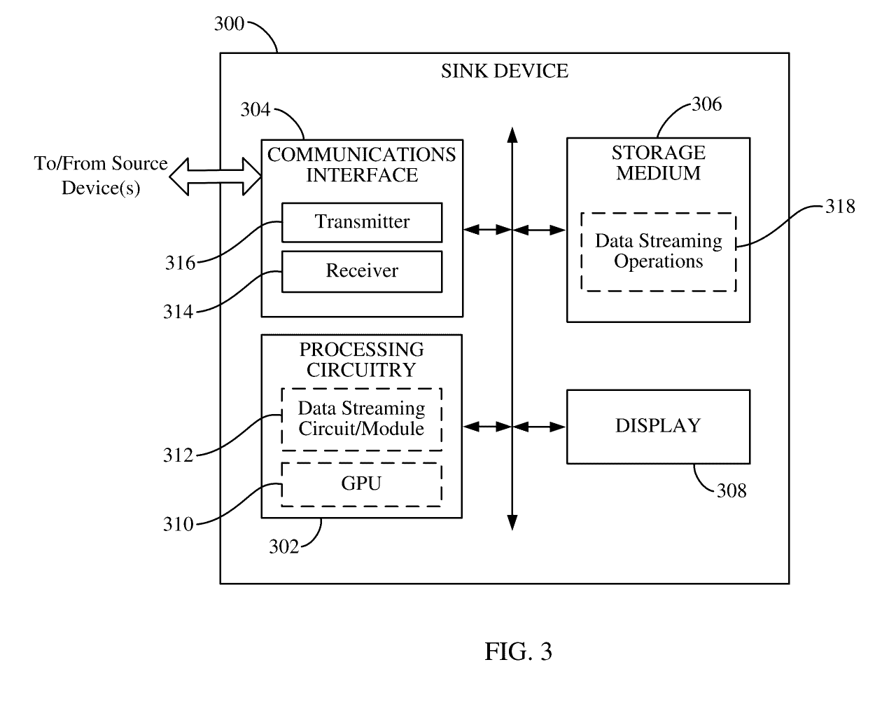

Turning now to FIG. 3, a block diagram is shown illustrating select components of a sink device 300 according to at least one example. The sink device 300 may include a processing circuitry or circuit 302 coupled to or placed in electrical communication with a communications interface 304, a storage medium 306, and a display 308.

The processing circuit 302 is arranged to obtain, process and/or send data, control data access and storage, issue commands, and control other desired operations. The processing circuit 302 may include circuitry adapted to implement desired programming provided by appropriate media and/or circuitry adapted to perform one or more functions described in this disclosure. The processing circuit 302 may be implemented and/or configured according to any of the examples of the processing circuitry 202 described above.

In some instances, the processing circuit 302 may include a graphics processing unit (GPU) 310 and/or a data streaming circuit or module 312. The GPU 310 generally includes circuitry and/or programming (e.g., programming stored on the storage medium 306) adapted for processing received video data and rendering frames of video data based on one or more texture elements and graphics commands for display by a user interface.

The data streaming circuit/module 312 may include circuitry and/or programming (e.g., programming stored on the storage medium 306) adapted to receive streamed video data from a source device. In some examples, the data streaming circuit/module 312 may receive video data over a USB communication channel. The data streaming circuit/module 312 may further provide the video data to the GPU 310 to be rendered for presentation at display 308.

As used herein, reference to circuitry and/or programming associated with the sink device 300 may be generally referred to as logic (e.g., logic gates and/or data structure logic).

The communications interface 304 is configured to facilitate wireless and/or wired communications of the sink device 300. For example, the communications interface 304 may include circuitry and/or programming adapted to facilitate the communication of information bi-directionally with respect to one or more source devices. In at least one example, the communications interface 304 may be coupled to one or more antennas (not shown), and includes wireless transceiver circuitry, including at least one receiver 314 (e.g., one or more receiver chains) and/or at least one transmitter 316 (e.g., one or more transmitter chains). The communications interface 304 may be configured as a USB interface according to at least one example. Such a USB interface is capable of facilitating USB-compliant communication of information bi-directionally with respect to one or more source devices.

The storage medium 306 may represent one or more processor-readable devices for storing programming, such as processor executable code or instructions (e.g., software, firmware), electronic data, databases, or other digital information. The storage medium 306 may be configured and/or implemented in a manner similar to the storage medium 206 described above.

The storage medium 306 may be coupled to the processing circuit 302 such that the processing circuit 302 can read information from, and write information to, the storage medium 306. That is, the storage medium 306 can be coupled to the processing circuit 302 so that the storage medium 306 is at least accessible by the processing circuit 302, including examples where the storage medium 306 is integral to the processing circuit 302 and/or examples where the storage medium 306 is separate from the processing circuit 302 (e.g., resident in the sink device 300, external to the sink device 300, distributed across multiple entities).

Like the storage medium 206, the storage medium 306 includes programming stored thereon. The programming stored by the storage medium 306, when executed by the processing circuit 302, causes the processing circuit 302 to perform one or more of the various functions and/or process steps described herein. For example, the storage medium 306 may include data streaming operations 318 adapted to cause the processing circuit 302 to receive video data from a source device via USB, and to facilitate the rendering of the video data. Thus, according to one or more aspects of the present disclosure, the processing circuit 302 is adapted to perform (independently or in conjunction with the storage medium 306) any or all of the processes, functions, steps and/or routines for any or all of the sink devices described herein (e.g., sink device 104, sink device 300). As used herein, the term “adapted” in relation to the processing circuit 302 may refer to the processing circuit 302 being one or more of configured, employed, implemented, and/or programmed (in conjunction with the storage medium 306) to perform a particular process, function, step and/or routine according to various features described herein.

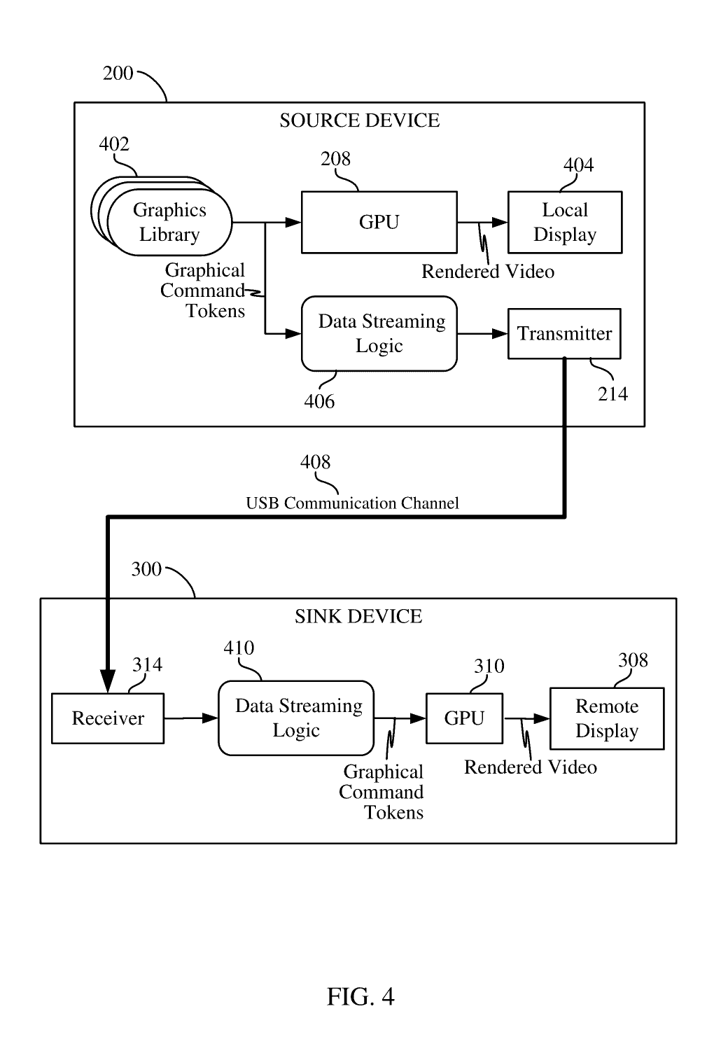

In operation, the source device 200 can transmit video data over a USB interface to the sink device 300, where the video data can be displayed by the sink device 300. FIG. 4 is a conceptual block diagram illustrating an example of a graphics domain transmission from the source device 200 to the sink device 300 according to at least one implementation of the present disclosure. As shown, a source device 200 includes video data associated with one or more application modules and depicted as a graphics library 402. The graphics library includes graphics commands (e.g., OpenGL/ES commands, vendor-specific commands) and texture elements. This video data typically is used by the graphics processing unit (GPU) 208 to render each frame for display at a local display 404. In some examples, the GPU 208 may render the video data and output the rendered video data to a local display 404. In some examples, the GPU 208 may not render the video data. The data streaming logic 406 (e.g., the data streaming circuit/module 210 and/or the data streaming operations 216) may capture the video data (e.g., the graphics commands and texture elements) at an input of the GPU 208, and may generate a token ID for each graphics command. For example, the data streaming logic 406 may include a token ID parser mechanism adapted to generate a token ID number and a command type for each graphics command (e.g., OpenGL/ES command, vendor specific command).

The data streaming logic 406 may generate a plurality of frames adapted for transmission of the captured video data over a USB communication channel 408. The transmitter 214 can output the video data to the sink device 300 over the USB communication channel 408. The transmitter 214 may be configured to output the video data as a wireless transmission and/or as a wired transmission, according to various implementations.

At the sink device 300, the video data sent over the USB communication channel 408 is received at the receiver 314. The receiver 314 can be configured to receive the video data as wireless transmissions and/or wired transmissions. The data streaming logic 410 (e.g., the data streaming circuit/module 312 and/or the data streaming operations 318) may process the received frames of the video data (e.g., graphics commands and texture elements), and can provide the video data to the GPU 310. The GPU 310 renders the graphics commands and texture elements into displayable frames for presentation at the display 308 of the sink device 300.

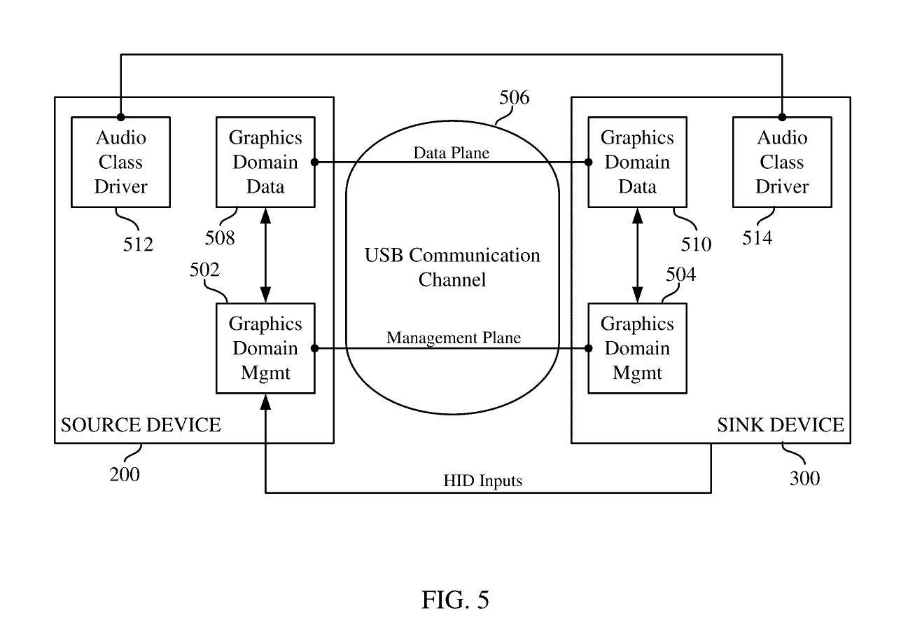

According to an aspect of the present disclosure, the graphics domain transmissions over a USB communication channel may include data transmissions in a data plane and command message transmissions in a management plane. FIG. 5 is a conceptual block diagram of a source device and a sink device communicating over a management plane and a data plane according to as least one example. As shown, a graphics domain management entity 502 at the source device 200 communicates with a graphics domain management entity 504 at the sink device 300 over a management plane utilizing a USB communication channel 506. The graphics domain management entity 502 in the source device 200 may be implemented by the data streaming logic (e.g., the data streaming circuit/module 210 and/or the data streaming operations 216) of the source device 200. Similarly, the graphics domain management entity 504 in the sink device 300 may be implemented by the data streaming logic (e.g., the data streaming circuit/module 312 and/or the data streaming operations 318) of the sink device 300.

The management plane can be configured to convey USB descriptors, also referred to herein as management commands (e.g., GET, SET, and NOTIF), over the USB communication channel 506 via a bulk endpoint (1 IN and 1 OUT). The management plane may also employ an optional interrupt endpoint (1 IN) or an optional isochronous endpoint (1 IN).

According to an aspect of the present disclosure, the management commands transmitted on the management plane can be employed to enable a communication session including graphics domain transmissions. As noted, the management commands can include GET, SET, and NOTIF commands. A GET command may be employed by the source device 200 to retrieve properties from the sink device 300. A SET command may be employed by the source device 200 to set a value of one or more properties at the sink device 300. A NOTIF command is employed by the sink device 300 to notify the source device 200 of one or more items, such as a change in a property value through external means.

A management sequence typically includes two phases. A first phase includes the source device 200 sending a command message to the sink device 300 over the management plane. The command message includes sufficient information for the sink device 300 to determine which property of the graphics domain is being referenced. After the sink device 300 decodes the received command message, the second phase includes execution of the command by the sink device 300, and return of an appropriate response message indicating either success or error.

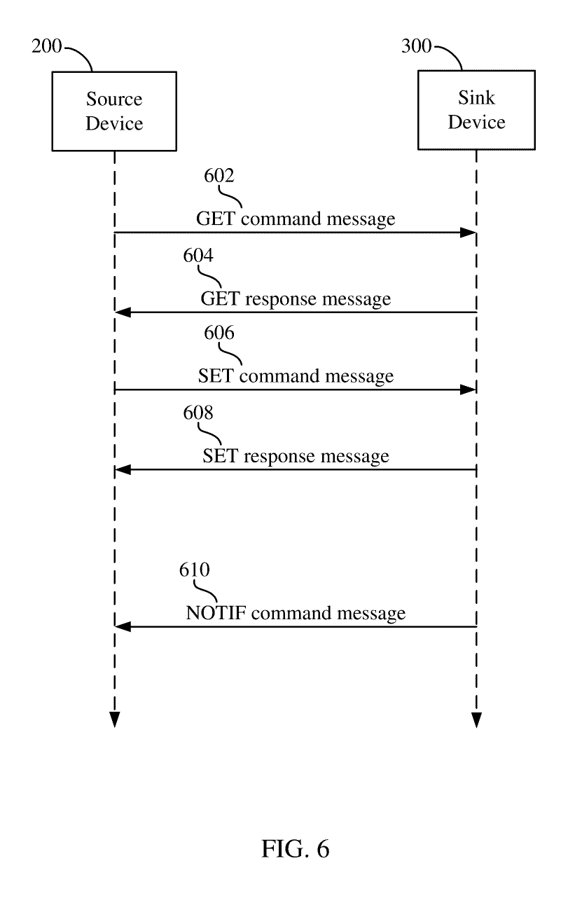

FIG. 6 is a flow diagram illustrating an example of message flow in the management plane according to at least one implementation. As shown, a source device 200 can send a GET command message 602 to a sink device 300 over a USB communication channel in the management plane. The GET command message 602 includes attributes to be queried about the graphics domain communication capabilities. The sink device 300 decodes the GET command message and responds by sending a GET response message 604 to the source device 200. The GET response message 604 indicates attributes or capabilities of the sink device for graphics domain communications by indicating property values for the various attributes. After receiving and decoding the GET response message 604 from the sink device 300, the source device 200 selects certain attributes and their property values for a graphics domain stream, and sends a SET command message 606 to the sink device 300 indicating those selected attributes and property values. The sink device 300 sends a SET response message 608 back to the source device 200 indicating whether setting each attribute and property value was successful or failed. With the foregoing information, the source device 200 and the sink device 300 can implement a graphics domain communication stream as set up through the GET and SET command communications.

After the graphics domain stream is initiated, it may occur that some change occurs at the sink device 300. In response to such a change, the sink device 300 may send a NOTIF command message 610 to the source device 200. The NOTIF command message 610 may include reason codes adapted to notify the source device 200 of a change in one or more property values by some external means.

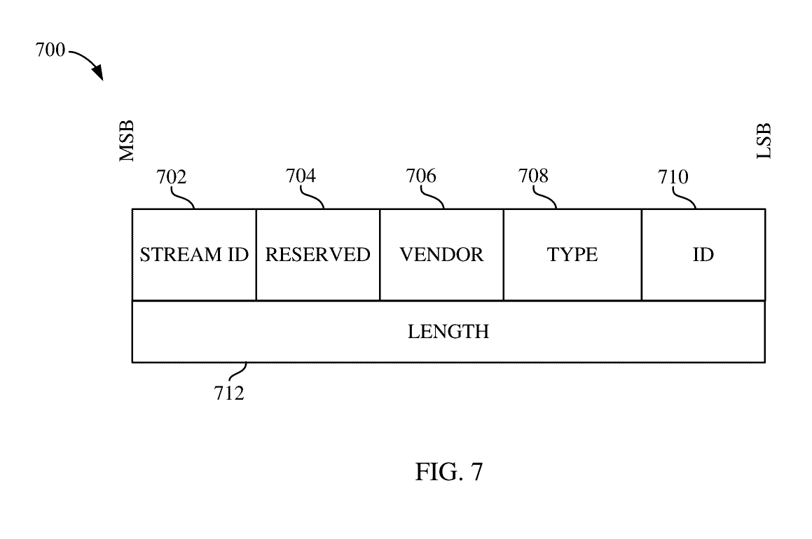

The command messages sent on the management plane may be formatted with a header section and a payload section. FIG. 7 is a block diagram illustrating one example of a header section for a command message according to the present disclosure. As depicted, the header section 700 includes a stream identifier (ID) field 702 that uniquely identifies the graphics domain frames. A stream ID field 702 is included to uniquely identify the graphics domain stream associated with the frame. In some implementations, the source device 200 and the sink device 300 may have more than one transmission stream in the graphics domain. The stream ID field 702 can identify to the sink device 300 which graphics domain stream the frame is associated with. In GET command messages, the stream ID field 702 can be ignored by the receiving device.

The header section 700 may further include a reserved field 704 and a vendor field 706. The vendor field 706 can be configured to indicate whether the payload is in a default format or in a vendor-specific format. According to at least one example, the default format may be an Augmented Backus-Naur Form (ABNF).

A type field 708 is included to indicate the type of command message that is included. For example, the type field 708 may be configured to indicate whether the command message is a GET command, SET command, or NOTIF command.

The header section 700 further includes an ID field 710. The ID field 710 is configured to identify the graphics domain management entity and its version. The ID field 710 can be significant if the management plane endpoint is being shared with other USB traffic. The header section 700 can include a length field 712 indicating the length of the payload section.

Referring back to FIG. 5, the graphics domain management entity 502 of the source device 200 may further receive human interface device (HID) inputs from the sink device 300. HID inputs can enable a user at the sink device 300 to enter a media control operation (e.g., play, pause, skip, rewind) or some other operation at the sink device 300, and to have that function carried out at the source device 200.

Still referring to FIG. 5, a graphics domain data entity 508 in the source device 200 communicates with a graphics domain data entity 510 in the sink device 300 over a data plane utilizing the USB communication channel 506. The graphics domain data entity 508 in the source device 200 may obtain video data from an internal intercept at the input of the local GPU, as described above. The graphics domain data entity 510 in the sink device 300 accepts video data from the graphics domain data entity 508 in the source device 200 to be rendered as described above. The graphics domain data entity 508 in the source device 200 may be implemented by the data streaming logic (e.g., the data streaming circuit/module 210 and/or the data streaming operations 216) of the source device 200. Similarly, the graphics domain data entity 510 in the sink device 300 may be implemented by the data streaming logic (e.g., the data streaming circuit/module 312 and/or the data streaming operations 318) of the sink device 300.

The data plane may be configured to convey graphics domain data messages over the USB communication channel 506 via dedicated endpoints. For example, the data plane may employ a bulk endpoint (1 IN and 1 OUT) or an isochronous endpoint (1 IN and 1 OUT).

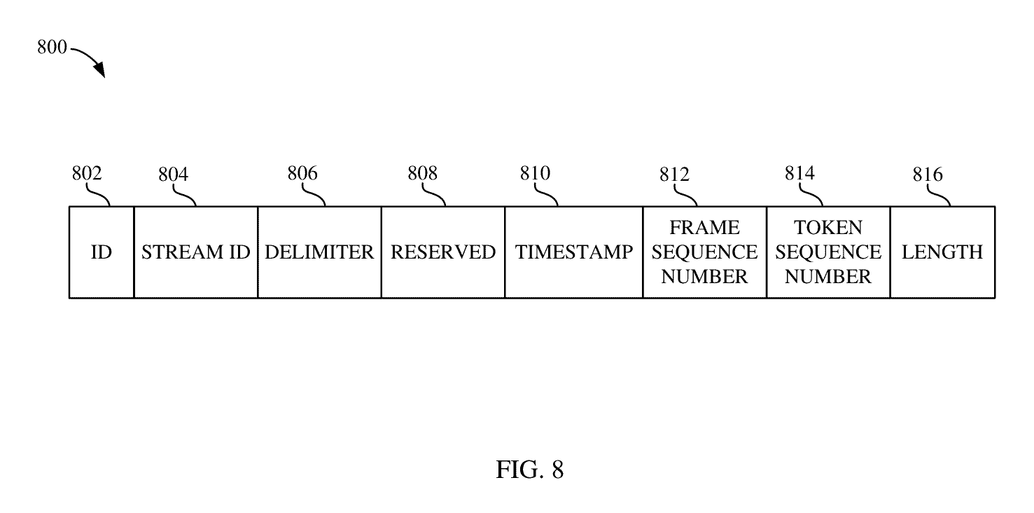

The graphics domain transmissions can be sent in graphics domain data frames including a header section and a payload section. FIG. 8 is a block diagram illustrating at least one example of a header section 800 of a graphics domain data frame for transmitting video data in the graphics domain. In the depicted example, the header section 800 includes an ID field 802 that uniquely identifies the graphics domain data frames. A stream ID field 804 is included to uniquely identify the graphics domain data stream associated with the frame. As noted above, the source device 200 and the sink device 300 may have more than one transmission stream in the graphics domain. The stream ID field 804 can identify which graphics domain stream the frame is associated with. A delimiter field 806 may be included to identify the start and end of the graphics domain data frame.

The header section 800 may further include a reserved field 808 and a timestamp field 810. The timestamp field 810 can be configured to indicate the presentation time for the graphics domain data frame to ensure time synchronization. For example, the timestamp field 810 may indicate the offset in milliseconds from the beginning of the graphics domain data stream when the present frame is to be rendered. That is, the timestamp field 810 may indicate the time T at which the data frame is to be rendered with respect to the start of the stream (T−0). In at least one implementation, the timestamp field 810 can range from 0 to (2³²−1) milliseconds (unsigned 32-bit number). The source device 200 and the sink device 300 may be synchronized either through use of an isochronous endpoint for the data plane or through use of other mechanisms (e.g., 802.1as) and a bulk endpoint.

The header section 800 further includes a frame sequence number field 812 and a token sequence number field 814. The frame sequence number field 812 is adapted to indicate the sequence number of the graphics domain data frame. In at least one example, the frame sequence number field 812 can start at 0, and can increment by 1 for each new graphics domain data frame.

The token sequence number field 814 is adapted to indicate the token number in the graphics domain data frame. A single graphics domain data frame may include a single token, or may include multiple tokens within a single frame. In at least one example, the token sequence number field 814 can start at 1, and can increment by the number of tokens included in the graphics data frame.

In some instances, two or more graphics domain data frames may have the same value for the frame sequence number field 812 if they carry fragments of the same payload. In such instances, the value of the token sequence number field 814 of the graphics domain data frame carrying the first fragment of the payload indicates the number of tokens present in the graphics data frame, while the token sequence number field 814 of the graphics data frames carrying the remaining fragments of the payload can be set to 0. The header section 800 can include a length field 816 indicating the length of the payload section.

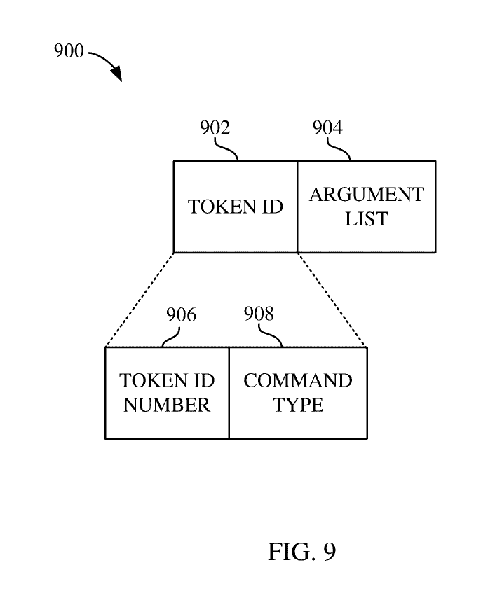

FIG. 9 is a block diagram illustrating at least one example of a payload section 900 of a graphics domain data frame for transmitting video data in the graphics domain. As shown, the payload section 900 can include a token identifier field 902 and an argument list field 904. The token identifier field 902 may include a token ID number field 906 and a command type field 908. The token ID number field 906 may include a value associated with OpenGL/ES commands or vendor-specific commands, as described above with reference to FIG. 4. For example, with OpenGL/ES commands the value for the token ID number field 906 may be generated by parsing the OpenGL/ES header files defined by the Khronos group for various versions of OpenGL/ES. The header file parser can read each line sequentially from beginning of the file to the end of the file, assign a value for the token ID number field 906 equal to 0 for the first command (function) in the file, and increment the value of the token ID number field 906 by 1 for each new command (function) in the file. For example, a header file parser may produce two independent token ID number tables on parsing g121.h and g12ext.h OpenGL/ES 3.1 header files as set forth by the Khronos Group. The command type field 908 of the token identifier field 902 can indicate the command type of the token ID number. For example, the command type field 908 can specify whether the token is an OpenGL/ES command, an EGL command, or a vendor-specific command.

The argument list field 904 of the payload section 900 can include a list of arguments associated with the token identifier field 902. A pointer to a memory location in the argument list can be de-referenced and substituted with a length field indicating the length of the content being pointed by the pointer, followed by the actual content being pointed by the pointer. The content may be texture information, array information, shader information, etc.

By way of an example of the payload fields described above, a source device 200 may send a frame with a value in the token identifier field 902 specifying a particular function. By way of example, the function may be a texture, a vertices, a shader, etc. Accordingly, the sink device 300 knows that the token is associated with a texture, a vertices, a shader etc., and also knows how many arguments are associated with the specified function and what the argument types will be. Because the source device 200 and sink device 300 know the function type, how many arguments there will be and the argument type, the values transmitted from the source device 200 to the sink device 300 simply need to be parsed.

Referring again to FIG. 5, audio data may also be conveyed from the source device 200 to the sink device 300 using USB audio class drivers 512, 514. The audio data may employ the timestamp generated from the same clock used for the video data, which is synchronized between the source device 200 and the sink device 300.

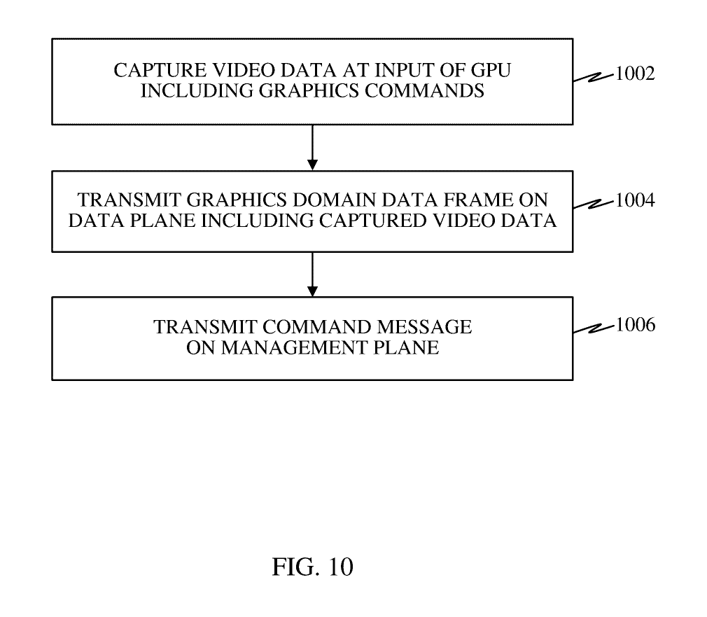

Turning to FIG. 10, a flow diagram is shown depicting at least one example of a method operational on a source device, such as the source device 200. Referring to FIGS. 2 and 10, source device 200 can capture video data at an input of a GPU at 1002. For example, the source device 200 may include logic (e.g., data streaming circuit/module 210 and/or data streaming operations 216) to capture video data at an input of the GPU 208. As noted previously, the captured video data includes graphics commands (e.g., OpenGL/ES commands, vendor-specific commands) and texture elements executable by a GPU.

At 1004, the source device 200 may transmit a graphics domain data frame on a data plane. For example, the source device 200 may include logic (e.g., data streaming circuit/module 210 and/or data streaming operations 216) to transmit a graphics domain data frame with the captured video data on the data plane via the communications interface 204. The transmission can be sent over a USB communication channel. As noted above, the data plane can employ a bulk endpoint and/or an isochronous endpoint according to USB communications. The graphics domain data frame may be configured as described above with reference to FIG. 8 and FIG. 9, including a header section and a payload section. As noted above, the header section may include a frame sequence number field and a token sequence number field among other fields. The payload section may include a token identifier field and an argument list field.

At 1006, the source device 200 may transmit a command message on a management plane. For example, the source device 200 may include logic (e.g., data streaming circuit/module 210 and/or data streaming operations 216) to transmit a command message on the management plane via the communications interface 204. The transmission can be sent over a USB communication channel. As noted above, the management plane can employ a bulk endpoint, an interrupt endpoint, and/or an isochronous endpoint according to USB communications. The payload of the command message may include a GET command message or a SET command message, as described above.

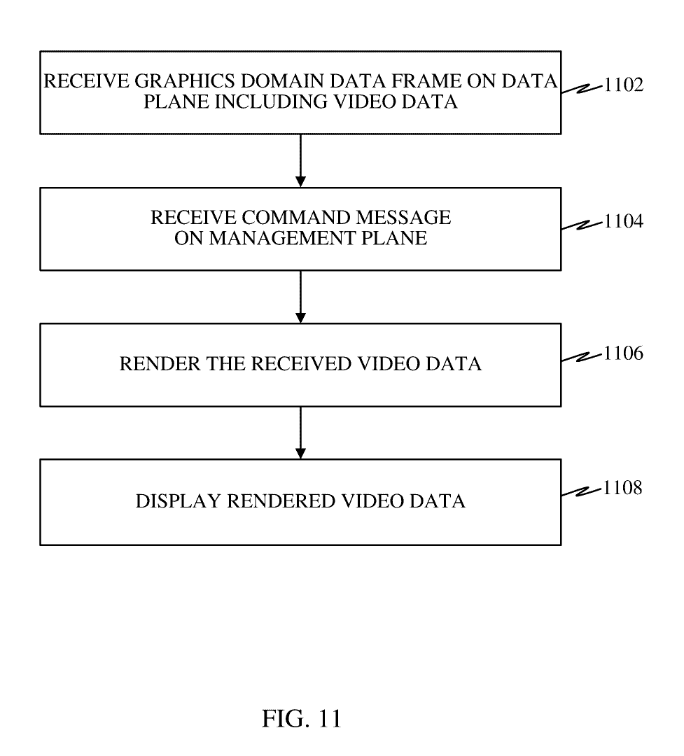

FIG. 11 is a flow diagram illustrating at least one example of a method operational on a sink device, such as the sink device 300. Referring to FIGS. 3 and 11, a sink device 300 may receive a graphics domain data frame on a data plane at 1102. For example, the sink device 300 may include data streaming logic (e.g., data streaming circuit/module 312 and/or data streaming operations 318) to receive a graphics domain data frame via the communications interface 304. The graphics domain data frame can be received over a USB communication channel, and may include video data with graphics commands (e.g., OpenGL/ES commands, vendor-specific commands) and texture elements executable by a GPU.

As noted above, the data plane can employ a bulk endpoint and/or an isochronous endpoint according to USB communications. The graphics domain data frame may be configured as described above with reference to FIG. 8 and FIG. 9, including a header section and a payload section. As noted above, the header section may include, among other fields, a frame sequence number field and a token sequence number field. The payload section may include a token identifier field and an argument list field, as described above.

At 1104, the sink device 300 may also receive at least one command message on a management plane. For example, the sink device 300 may include data streaming logic (e.g., data streaming circuit/module 312 and/or data streaming operations 318) to receive a command message via the communications interface 304. The command message can also be received over the USB communication channel on the management plane. As noted above, the management plane can employ a bulk endpoint, an interrupt endpoint, and/or an isochronous endpoint according to USB communications. The payload of the command message may include a GET command message or a SET command message, as described above.

At 1106, the sink device 300 can render the received video data. For example, the sink device 300 may render the video data included in the received graphics domain data frame at the GPU 310. That is, the GPU 310 may render the video data based on the included graphics commands and texture elements).

At 1108, the sink device 300 can display the rendered video data. For example, the display 308 may visually present the video data rendered by the GPU 310.

While the above discussed aspects, arrangements, and embodiments are discussed with specific details and particularity, one or more of the components, steps, features and/or functions illustrated in FIGS. 1, 2, 3, 4, 5, 6, 7, 8, 9, 10, and/or 11 may be rearranged and/or combined into a single component, step, feature or function or embodied in several components, steps, or functions. Additional elements, components, steps, and/or functions may also be added or not utilized without departing from the present disclosure. The apparatus, devices and/or components illustrated in FIGS. 1, 2, 3, 4, and/or 5 may be configured to perform or employ one or more of the methods, features, parameters, and/or steps described in FIGS. 6, 7, 8, 9, 10, and/or 11. The novel algorithms described herein may also be efficiently implemented in software and/or embedded in hardware.

While features of the present disclosure may have been discussed relative to certain embodiments and figures, all embodiments of the present disclosure can include one or more of the advantageous features discussed herein. In other words, while one or more embodiments may have been discussed as having certain advantageous features, one or more of such features may also be used in accordance with any of the various embodiments discussed herein. In similar fashion, while exemplary embodiments may have been discussed herein as device, system, or method embodiments, it should be understood that such exemplary embodiments can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. A source device, comprising:
a universal serial bus (USB) communications interface;
a graphics processing unit (GPU); and
a processing circuit coupled to the USB communications interface and the GPU, the processing circuit comprising logic to:
capture GPU-executable video data at an input of the GPU, the GPU-executable video data including a set of graphics commands;
transmit a graphics domain data frame on a data plane via the USB communications interface, the graphics domain data frame including the GPU-executable video data; and
transmit at least one command message on a management plane via the USB communications interface.

2. The source device of claim 1, wherein the data plane employs at least one of a bulk endpoint or an isochronous endpoint.

3. The source device of claim 1, wherein the management plane employs at least one of a bulk endpoint, an interrupt endpoint, or an isochronous endpoint.

4. The source device of claim 1, wherein the logic to transmit at least one command message on the management plane via the USB communications interface comprises logic to:
transmit a GET command message querying about at least one graphics domain capability; and
transmit a SET command message indicating selected attributes and property values for a graphics domain communication stream.

5. The source device of claim 1, wherein the logic to transmit the graphics domain data frame on the data plane via the USB communications interface comprises logic to generate a graphics domain data frame including a header and a payload, wherein the header comprises a frame sequence number field and a token sequence number field.

6. The source device of claim 1, wherein the logic to transmit the graphics domain data frame on the data plane via the USB communications interface comprises logic to generate a graphics domain data frame including a header and a payload, wherein the payload comprises a token identifier field and an argument list field.

7. A method operational on source device, comprising:
capturing video data at an input of a graphics processing unit (GPU), the video data including a set of graphics commands executable by a GPU;
transmitting a graphics domain data frame on a data plane via a universal serial bus (USB) communications channel, the graphics domain data frame including the captured video data; and
transmitting at least one command message on a management plane via the USB communications channel.

8. The method of claim 7, wherein transmitting the graphics domain data frame on the data plane comprises:
transmitting the graphics domain data frame on the data plane employing at least one of a bulk endpoint or an isochronous endpoint.

9. The method of claim 7, wherein transmitting at least one command message on a management plane comprises:
transmitting at least one command message on a management plane employing at least one of a bulk endpoint, an interrupt endpoint, or an isochronous endpoint.

10. The method of claim 7, wherein transmitting at least one command message on the management plane via the USB communications channel comprises:
transmitting a GET command message querying about at least one graphics domain capability; and
transmitting a SET command message indicating selected attributes and property values for a graphics domain communication stream.

11. The method of claim 7, wherein transmitting the graphics domain data frame on the data plane comprises:
generating a graphics domain data frame including a header and a payload, wherein the header comprises a frame sequence number field and a token sequence number field.

12. The method of claim 7, wherein transmitting the graphics domain data frame on the data plane comprises:
generating a graphics domain data frame including a header and a payload, wherein the payload comprises a token identifier field and an argument list field.

13. A sink device, comprising:
a universal serial bus (USB) communications interface;
data streaming logic configured to
receive a graphics domain data frame on a data plane via the USB communications interface, the graphics domain data frame including video data comprising a set of graphics commands executable by a graphics processing unit, and
receive at least one command message on a management plane via the USB communications interface;
a graphics processing unit (GPU) configured to render the video data included in the received graphics domain data frame; and
a display device configured to display the rendered video data.

14. The sink device of claim 13, wherein the data plane employs at least one of a bulk endpoint or an isochronous endpoint.

15. The sink device of claim 13, wherein the management plane employs at least one of a bulk endpoint, an interrupt endpoint, or an isochronous endpoint.

16. The sink device of claim 13, wherein the at least one command message received on the management plane via the USB communications interface comprises at least one of:
a GET command message querying about at least one graphics domain capability; or
a SET command message indicating selected attributes and property values for a graphics domain communication stream.

17. The sink device of claim 13, wherein the received graphics domain data frame comprises a header and a payload, wherein the header comprises a frame sequence number field and a token sequence number field.

18. The sink device of claim 13, wherein the received graphics domain data frame comprises a header and a payload, wherein the payload comprises a token identifier field and an argument list field.

19. A method operational on sink device, comprising:
receiving a graphics domain data frame on a data plane via a universal serial bus (USB) communications channel, the graphics domain data frame including video data comprising a set of graphics commands executable by a graphics processing unit;
receiving at least one command message on a management plane via the USB communications channel;
rendering the video data included in the received graphics domain data frame; and
displaying the rendered video data.

20. The method of claim 19, wherein receiving the graphics domain data frame on the data plane comprises:
receiving the graphics domain data frame on the data plane employing at least one of a bulk endpoint or an isochronous endpoint.

21. The method of claim 19, wherein receiving at least one command message on the management plane comprises:
receiving at least one command message on the management plane employing at least one of a bulk endpoint, an interrupt endpoint, or an isochronous endpoint.

22. The method of claim 19, wherein receiving at least one command message comprises receiving at least one of:
a GET command message querying about at least one graphics domain capability; or
a SET command message indicating selected attributes and property values for a graphics domain communication stream.

23. The method of claim 19, wherein receiving the graphics domain data frame on the data plane comprises:
receiving the graphics domain data frame including a header and a payload, wherein the header comprises a frame sequence number field and a token sequence number field.

24. The method of claim 19, wherein receiving the graphics domain data frame on the data plane comprises:
receiving the graphics domain data frame including a header and a payload, wherein the payload comprises a token identifier field and an argument list field.
